(19) United States
(12) Patent Application Publication
(10) Pub. No.: US 2026/0226939 A1
(43) Pub. Date: Aug. 6, 2026

(54) MONOLITHIC PIVOT BEARING

(71) Applicant: Raytheon Company, Arlington, VA (US)

(72) Inventors: Scott R. Foes, Torrance, CA (US); Tyler W. Garcia, Cypress, CA (US); Rick L. Cantrell, Redondo Beach, CA (US); Michael L. Menendez, Hawthorne, CA (US); Andrew Truxel, Hermosa Beach, CA (US)

(21) Appl. No.: 19/046,177

(22) Filed: Feb. 5, 2025

(51) Int. Cl. F16C 11/12

(52) U.S. Cl. CPC F16C 11/12; F16C 2326/47

(57) ABSTRACT

A monolithic pivot bearing having an outer portion where a limiter extends from the outer portion is provided. The bearing has an inner portion within the outer portion that is rotatable with respect to the outer portion. The inner portion defines a limiter recess that receives the limiter. A limiter width and a limiter recess width define a bearing travel range. Flexure blades having a serpentine configuration are disposed within flexure blade recesses of the bearing. The blades couple the outer portion with the inner portion. The blades flex into a first position when the inner portion or the outer portion rotates in a first direction relative to the other of the inner or outer portions. The blades flex into a second position when the inner portion or the outer portion rotates in a second direction relative to the other of the inner or outer portions.

### TECHNICAL FIELD

Examples relate to bearings and more specifically to monolithic pivot bearings.

### BACKGROUND

Aerospace applications can include components that require precise rotation in order to properly function. Examples can include mirror assemblies for satellites, missile guidance systems, and aircraft fuel controls. Pivot bearings can be used to provide precise angular rotation. Pivot bearings provide frictionless angular rotation by avoiding the use of components that rub with each other.

In order to provide frictionless rotation, pivot bearings are constructed from multiple components that interconnect with each other through welding, brazing, and/or various joints. Examples can include welded flex pivots and bolted flex pivots. However, the use of multiple components increases the likelihood of part failure. For example, failure can occur at a weld spot, a brazing spot, or one of the joints, which can cause failure of a component that uses the Pivot bearing.

### BRIEF DESCRIPTION OF DRAWINGS

FIG. 1 illustrates a spacecraft on which examples described herein may be used.

FIGS. 2A and 2B show a monolithic pivot bearing that can be used with the spacecraft of FIG. 1.

FIG. 3 illustrates a flexure blade of the monolithic pivot bearing of FIGS. 2A and 2B.

FIGS. 4A, 4B, 5A, and 5B illustrate relative motion between an outer cylindrical portion and an inner portion of the monolithic pivot bearing of FIG. 2 along with different flexure blade positions of the flexure blade of FIG. 3.

FIG. 6 shows a limiter and a limiter recess of the monolithic pivot bearing of FIG. 2.

FIG. 7 illustrates the monolithic pivot bearing of FIG. 2 coupled with an article.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to a monolithic pivot bearing that guides rotational motion between moving parts. The monolithic pivot bearing can be fabricated from a single piece of material, thereby avoiding welding, brazing, and/or multiple joints along with the propensity of failure that welding, brazing, and/or multiple joints can cause. The monolithic pivot bearing has an outer cylindrical portion and an inner portion disposed within the outer cylindrical portion. The monolithic pivot bearing includes flexure blades that function to operatively couple the outer cylindrical portion with the inner portion.

Each flexure blade has a serpentine configuration where each flexure blade extends from the outer cylindrical portion to the inner portion. The flexure blades are disposed within flexure blade recesses defined by the inner portion. Each flexure blade has a flexure blade thickness that can be controlled between a first thickness and a second thickness based on an application of the monolithic pivot bearing. In addition, each flexure blade has a length that can be controlled between a first length and a second length based on an application of the monolithic pivot bearing. Moreover, the flexure blade thickness and the flexure blade length can be simultaneously controlled based on an application of the monolithic pivot bearing.

Each of the flexure blades can be configured to flex in a first direction during relative rotation between the inner portion and the outer cylindrical portion in a first direction. Moreover, each of the flexure blades can be configured to flex in a second direction opposite the first direction during relative rotation between the inner portion and the outer cylindrical portion in a second direction that is opposite to the first direction.

The monolithic pivot bearing also has a limiter, which can be configured to limit angular motion of the monolithic pivot bearing. The inner portion can define a limiter recess configured to receive the limiter. The limiter can extend from an inner surface of the outer cylindrical portion. The limiter in conjunction with the limiter recess can define a travel range of the monolithic pivot bearing. As used herein, the travel range of the monolithic pivot bearing can relate to the angular motion of the monolithic pivot bearing.

In examples, the limiter can be configured to control the travel range. A width of the limiter can be varied to control the travel range of the monolithic pivot bearing. Alternatively, a width of the limiter recess can be controlled to control the travel range of the monolithic pivot bearing. In further examples, each of the limiter width and the limiter recess width can be simultaneously varied to control the travel range of the monolithic pivot bearing.

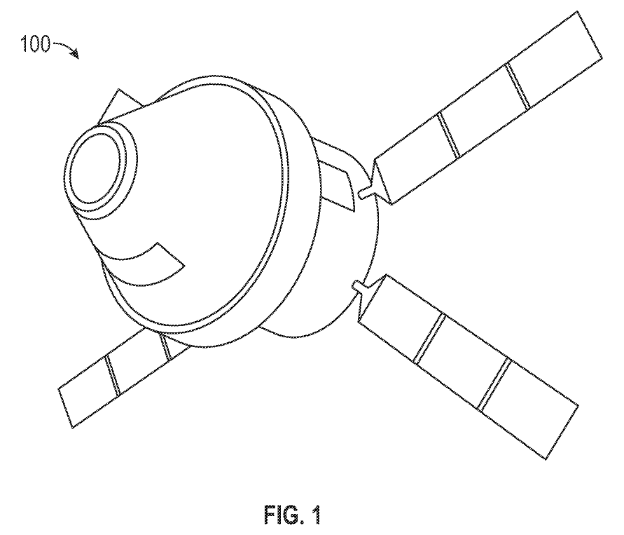

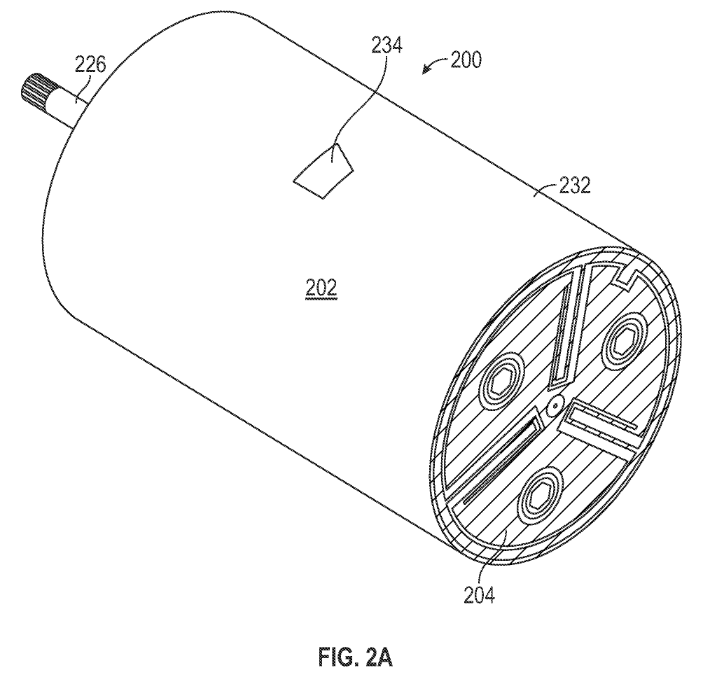

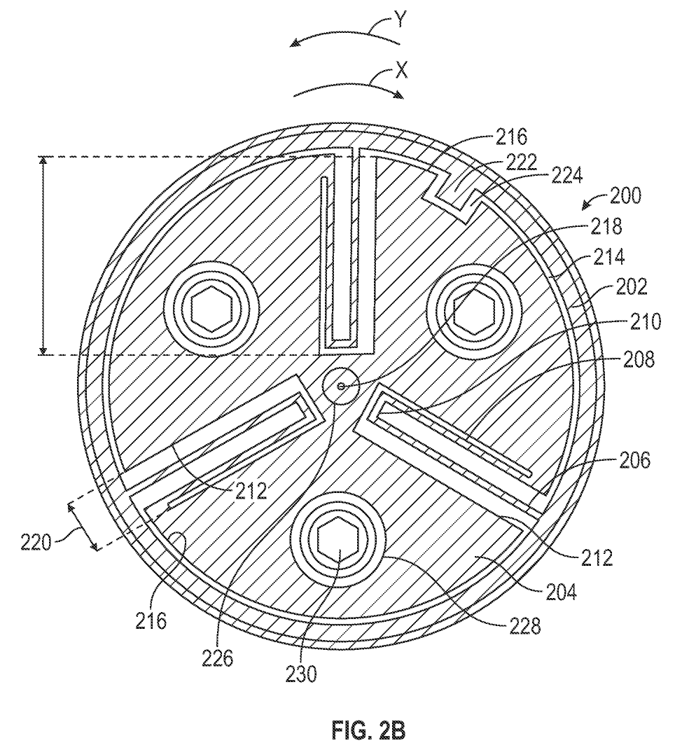

Now referring to FIG. 1, a spacecraft 100 is shown in which a monolithic pivot bearing 200 (FIGS. 2A and 2B) can be disposed and used. While a spacecraft 100 is shown in which the monolithic pivot bearing 200 can be disposed and used, examples are not limited to the spacecraft 100 and instead the monolithic pivot bearing 200 can be used in any type of application, such as, but not limited to, aircraft, automotive, automation, robotics, toy industries, or the like. Moreover, the monolithic pivot bearing 200 can be used with fast steering mirrors, gimbals, optical mounts, door hinges, articulating joints, or any other type of device or assembly requiring precise angular motion.

The monolithic pivot bearing 200 can include an outer cylindrical portion 202 along with an inner portion 204 disposed within the outer cylindrical portion 204 as shown with reference to FIGS. 2A and 2B. During operation of the monolithic pivot bearing 200, the inner portion 204 can rotate relative to the outer cylindrical portion 202 along a direction X and along a direction Y. Here, the outer cylindrical portion 202 can remain stationary while the inner portion 204 rotates along the directions X and Y. Alternatively, during operation of the monolithic pivot bearing 200, the outer cylindrical portion 202 can rotate relative to the inner portion 204 along the direction X and along the direction Y. In this instance, the inner portion 204 can remain stationary while the outer cylindrical portion 202 rotates along the directions X and Y. In further examples, the outer cylindrical portion 202 can rotate along the direction X while the inner portion 204 rotates along the direction Y. Moreover, the outer cylindrical portion 202 can rotate along the direction Y while the inner portion 204 rotates along the direction X. Rotation of the outer cylindrical portion 202 relative to the inner portion 204 along the directions X and Y and rotation of the inner portion 204 relative to the outer cylindrical portion 202 along the directions X and Y will be referred to herein as relative rotation between the outer cylindrical portion 202 and the inner portion 204.

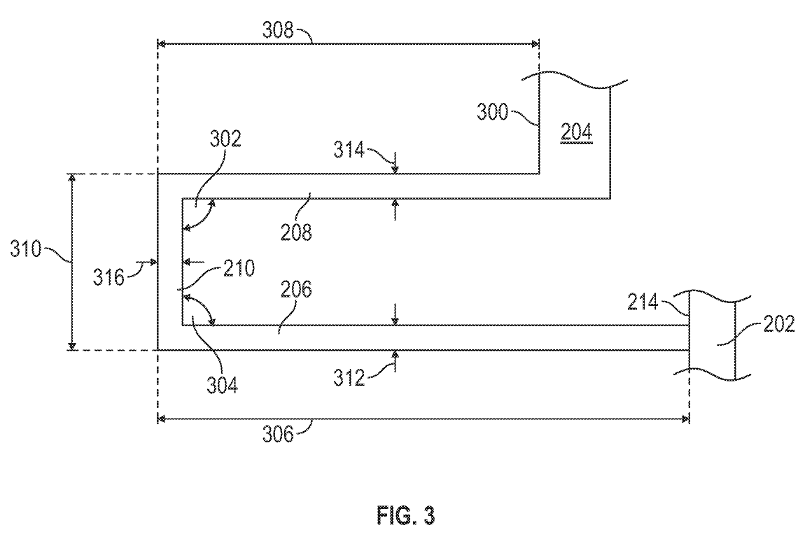

The monolithic pivot bearing 200 can include flexure blades 206-210 that extend between the outer cylindrical portion 200 and the inner portion 204 within a flexure blade recess 212. As can be seen with reference to FIGS. 2B and 3, the flexure blades 206-210 can have a serpentine configuration where the flexure blade 208 extends from the inner portion at an inner surface 300 of the inner portion to the flexure blade 210 in the flexure blade recess 212. In a static flexure blade position shown with reference to FIG. 3, the flexure blade 208 is perpendicular to the flexure blade 210 as shown at 302.

The flexure blade 210 can extend between the flexure blade 208 and the flexure blade 206, where the flexure blade 206 is perpendicular to the flexure blade 210, as shown at 304, in the static flexure blade position. In the static flexure blade position, the flexure blade 206 can be parallel to the flexure blade 208, as shown with reference to FIG. 2B. Furthermore, the flexure blade 206 can extend between the flexure blade 210 and an inner surface 214 of the outer cylindrical portion 202 within the flexure blade recess 212. By virtue of coupling with both the inner portion inner surface 300 and the outer cylindrical portion inner surface 214, the flexure blades 206-210 operatively couple the outer cylindrical portion 202 with the inner portion 204.

Still sticking with FIG. 3, each of the flexure blades 206-210 can have a variable length and a variable width. The flexure blade 206 can have a length 306 and the flexure blade 208 can have a length 308. In addition, the flexure blade 210 can have a length 310. As can be seen with reference to FIG. 3, the flexure blade length 308 can be less than the flexure blade length 306. Moreover, the flexure blade length 310 can be less than the flexure blade length 306 and the flexure blade length 308. However, examples are not limited to the description in FIG. 3 and examples envision any combination of flexure blade lengths relative to each other. To further illustrate, the flexure blade length 310 can be greater than the flexure blade lengths 306 and 308, equal to the flexure blade lengths 306 and 308, or greater than the flexure blade length 308 and less than the flexure blade length 306. Furthermore, the flexure blade length 306 can be less than the flexure blade length 308 and the flexure blade length 310. In addition, the flexure blade length 308 can be greater than the flexure blade length 306 and less than the flexure blade length 310.

Each of the flexure blades 206-210 can have variable thicknesses. The flexure blade 206 can have a thickness 312 and the flexure blade 208 can have a thickness 314. Furthermore, the flexure blade 210 can have a thickness 316. In the example shown with reference to FIG. 3, each of the thickness 312-316 are the same. Nonetheless, the thicknesses 312-316 can vary relative to each other. To further illustrate, the flexure blade thickness 312 can be greater than the flexure blade thicknesses 314 and 316 or greater than the flexure blade thickness 314 and less than the flexure blade thickness 316. Furthermore, the flexure blade thickness 314 can be less than the flexure blade thicknesses 312 and 316. In addition, the flexure blade thickness 316 can be greater than the flexure blade thickness 312 and less than the flexure blade thickness 314.

As mentioned above, the flexure blades 206-210 can be disposed within the flexure blade recess 212. The flexure blade recess 212 can be within the inner portion 204. The flexure blade recess 212 can extend from a top surface 216 of the inner portion 204 towards a center 218 of the inner portion 204. Moreover, the flexure blade recess 212 can have a width 220 that allows for the flexure blades 206-210 to move between different flexure blade positions within the flexure bladerecess 212. As noted above, in FIGS. 2A, 2B, and 3, the flexure blades 206-210 can have a static flexure blade position where there is no relative rotation between the outer cylindrical portion 202 and the inner portion 204.

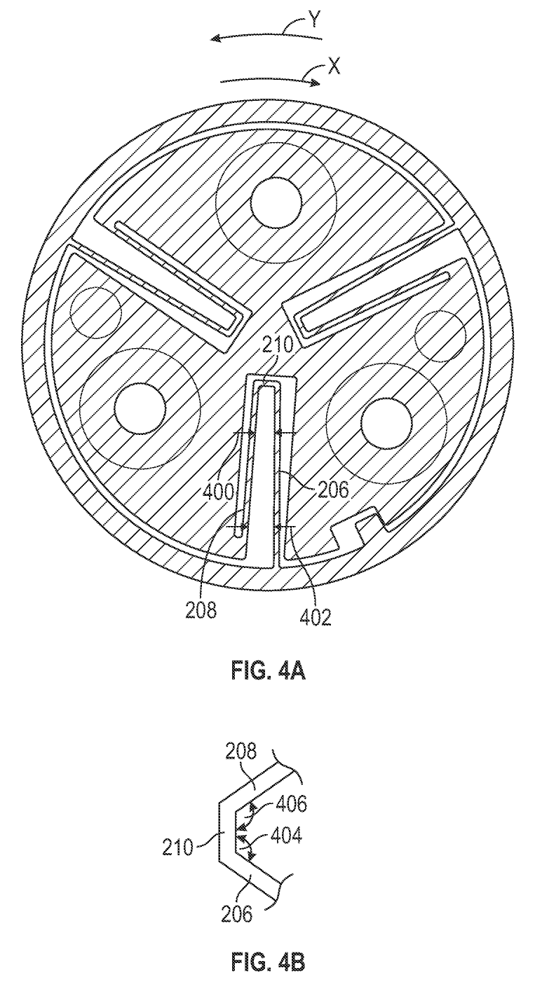

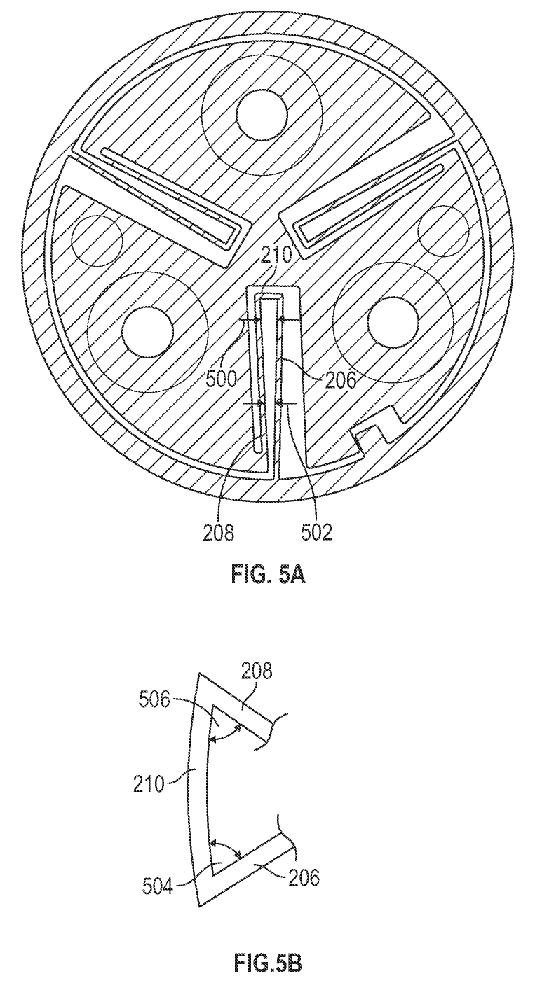

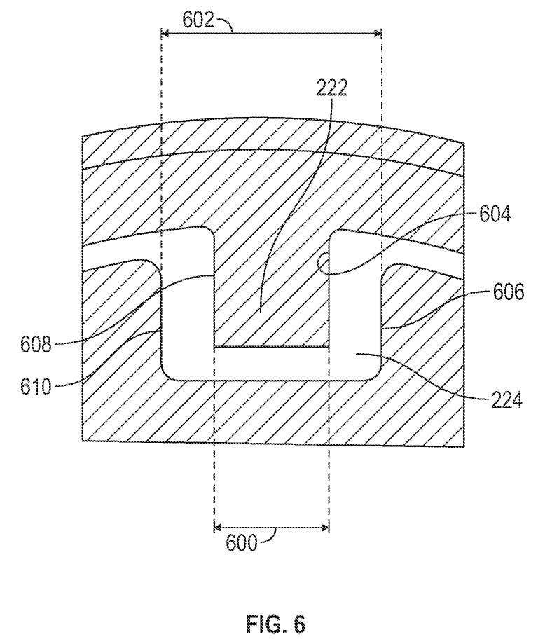

During relative rotation between the outer cylindrical portion 202 and the inner portion 204, the flexure blades 206-210 can move between an obtuse flexure blade position, as shown with reference to FIGS. 4A and 4B, and an acute flexure blade position, as shown with reference to FIGS. 5A and 5B. In FIGS. 4A and 4B, the flexure blades 206-210 can have an obtuse flexure blade position when relative rotation between the outer cylindrical portion 202 and the inner portion 204 occurs along the direction X or the direction Y. In the obtuse flexure blade position as shown with reference to FIGS. 4A and 4B, the flexure blades 206 and 208 extend away from each other as shown at a distance 400 and a distance 402. The distance 402 is greater than the distance 400, which indicates that the flexure blades 206 and 208 extend away from each other. Moreover, the flexure blade 206 forms an obtuse angle 404 with the flexure blade 210. In addition, the flexure blade 208 forms an obtuse angle 406 with the flexure blade 210. The obtuse angle 404 can be: greater than the obtuse angle 406, less than the obtuse angle 406, or the same as the obtuse angle 406. The obtuse angles 404 and 406 can vary as relative rotation occurs between the outer cylindrical portion 202 and the inner portion 204.

In the acute angle flexure blade position as shown with reference to FIGS. 5A and 5B, the flexure blades 206 and 208 extend towards each other as shown at a distance 500 and a distance 502. More specifically the distance 502 is less than the distance 500, which indicates that the flexure blades 206 and 208 extend towards each other. Moreover, the flexure blade 206 forms an acute angle 504 with the flexure blade 210. In addition, the flexure blade 208 forms an acute angle 506 with the flexure blade 210. The acute angle 404 can be: greater than the acute angle 406, less than the acute angle 406, or the same as the acute angle 406. The acute angles 504 and 506 can vary as relative rotation occurs between the outer cylindrical portion 202 and the inner portion 204.

Referring attention back to FIG. 2B, the monolithic pivot bearing 200 can be configured to limit angular motion along the directions X and Y by defining a travel range. More specifically, a limiter 222 can extend from the outer cylindrical portion inner surface 214 and into a limiter recess 224 that is configured to receive the limiter 222 as shown with reference to FIGS. 2B and 6. The limiter recess 224 can extend from the inner portion top surface 216 towards the inner portion center 218. The limiter 222 could also be inverted such that it extends from the inner cylindrical surface of 204 into a recess in the outer cylindrical surface 202

The limiter 222 can have a width 600 that is less than a width 602 of the limiter recess 224, i.e., the limiter recess width 602 is greater than the limiter width 600, as shown with reference to FIG. 6. The combination of the limiter width 600 and the limiter recess width 602 can define a travel range of the monolithic pivot bearing 200. The travel range of the monolithic pivot bearing 200 can be limited to when a sidewall 604 of the limiter 222 contacts a sidewall 606 of the limiter recess 224 during relative rotation between the outer cylindrical portion 202 and the inner portion 204. The travel range can be also limited to when a sidewall 608 of the limiter 222 contacts a sidewall 610 of the limiter recess 224 during relative rotation between the outer cylindrical portion 202 and the inner portion 204.

A number of variables can be used to control the travel range of the monolithic pivot bearing 200. The limiter width 600 can be increased or decreased to define the travel range. Likewise, the limiter recess width 602 can be increased or decreased to define the travel range. Moreover, a combination of the limiter width 600 and the limiter recess width 602 can be increased or decreased to define the travel range. The travel range can be defined to limit relative rotation between the outer cylindrical portion 202 and the inner portion 204 to a range between 1° and 10° along the directions X and Y. Moreover, the travel range can also be less than 1° and greater than 10° along the directions X and Y.

The flexure blades 206-210 can be configurable based on an application of the monolithic pivot bearing 200. The monolithic pivot bearing 200 is described herein as having three sets of flexure blades that each have the flexure blades 206-210. However, examples envision monolithic pivot bearings having any number of flexure blades depending on an application of the monolithic pivot bearing 200.

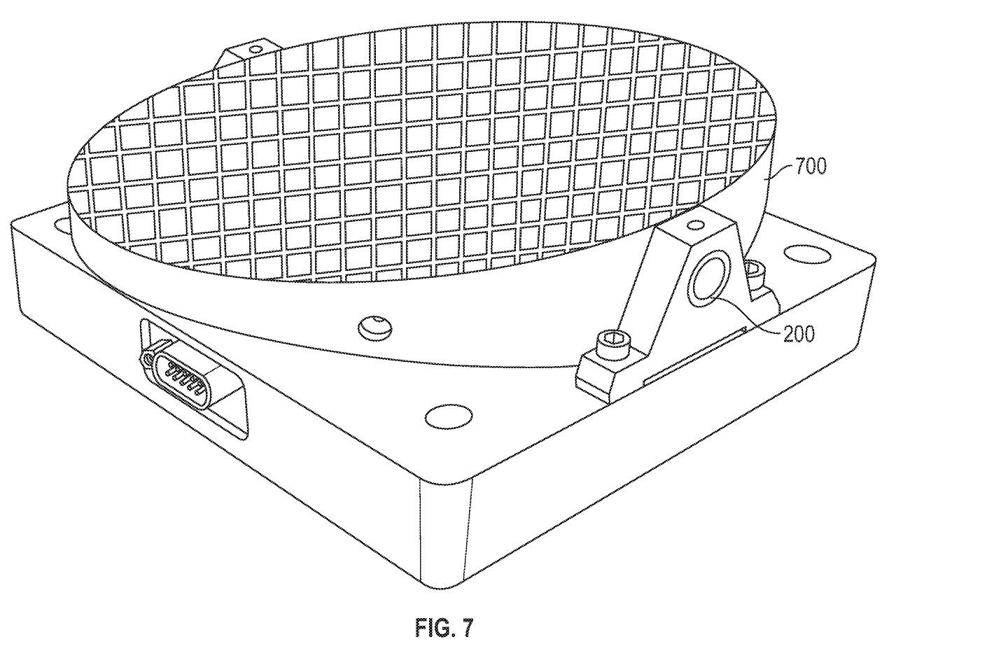

The monolithic pivot bearing 200 can be configured to couple with other monolithic pivot bearings or to couple with various articles, such as an article 700 shown with reference to FIG. 7. In order to facilitate coupling with other monolithic pivot bearings or various articles, the monolithic pivot bearing 200 can include a coupling member 226. While shown as a shaft having a circular configuration, the coupling member 226 can have any type of configuration that facilitates coupling between the monolithic pivot bearing 200 and another monolithic pivot bearing or an article, such as a shaft having the shape of a polygon. Moreover, the coupling member 226 can include a clamp that allows for clamping between an article or another monolithic pivot bearing or a bonding, such as an adhesive, brazing, or welding, that allows for coupling of the inner portion 204 with an article or another monolithic pivot bearing. In addition, the coupling member 226 can include a bolted flange along with a fastener and pin assembly that is internal to the inner portion 204 and allows for coupling of the inner portion 204 with an article or another monolithic pivot bearing.

The coupling member 226 can be part of the monolithic pivot bearing such that the coupling member 226 rotates as the inner portion 204 rotates as described herein. Moreover, a second monolithic pivot bearing or an article can have a recess configured to receive the coupling member such that the monolithic pivot bearing 200 and the second monolithic pivot bearing are rigidly coupled with each and effect the same type of rotation, such as relative rotation between the outer cylindrical portion and the inner portion for the monolithic pivot bearing 200 and the second monolithic pivot bearing.

In examples where the article 700 is configured to receive the coupling member 226, the article 700 can have a recess configured to receive the coupling member such that the monolithic pivot bearing 200 and the article 700 are rigidly coupled with each other and effect the same type of rotation, such as relative rotation between the outer cylindrical portion and the inner portion for the monolithic pivot bearing 200 and the article 700. The article 700 can be a fast steering mirror where the mirror can rotate along the directions X and Y when the inner portion 204 rotates along the directions X and Y by virtue of the coupling member 226. Therefore, precise rotation of the inner member 204 is transferred to the article 700 such that the article 700 can be precisely rotated via the monolithic pivot bearing 200. While the article 700 is described as being a mirror, the article 700 can be type of device or assembly suitable for precise angular motion as described herein. Examples can include gimbals, optical mounts, door hinges, articulating joints, or any other type of device or assembly requiring precise angular motion.

In addition to the coupling member 226, the monolithic pivot bearing 200 can also include mounting interfaces 228 that can be used to couple the monolithic pivot bearing 200 with additional monolithic pivot bearings or articles. The mounting interfaces 228 can include any type of assembly that facilitates coupling of the monolithic pivot bearing 200 with a second monolithic pivot bearing or an article, such as a fastener 230, or the like. The mounting interfaces 228 are disposed at the inner portion 204. Thus, the mounting interfaces can be used to rigidly couple the inner portion 204 to a second monolithic pivot bearing, an article, or a surface.

In scenarios where the mounting interfaces 228 rigidly couple the inner portion 204 to a surface, during relative rotation between the outer cylindrical portion 202 and the inner portion 204, the inner portion 204 can remain stationary while the outer cylindrical portion 200 can rotate along the directions X and Y. Therefore, an outer surface 232 of the outer cylindrical portion 202 can rotate an article that is rigidly attached to the outer cylindrical portion outer surface 232 via coupling interfaces 234 (one shown).

Characteristics of the flexure blades 206-210, such as the flexure blade lengths 306-310 and the flexure blade thicknesses 312-316, can be controlled based on an application of the monolithic pivot bearing 200. For example, the flexure blade lengths 306-310 can be controlled between a first length and a second length based on an application of the monolithic pivot bearing 200. Thus, if the monolithic pivot bearing 200 is being used for larger applications, such as if a diameter of the monolithic pivot bearing 200 exceeds two inches, the flexure blade lengths 306-310 can be increased. Furthermore, if the monolithic pivot bearing 200 is being used for smaller applications, such as if a diameter of the monolithic pivot bearing 200 is smaller than two inches, the flexure blade lengths 306-310 can be decreased. Moreover, based on the application and a diameter of the monolithic pivot bearing 200, the flexure blade lengths 306-310 can vary relative to each other as discussed above.

The flexure blade thicknesses 312-316 can also be varied based on an application of the monolithic pivot bearing 200. For example, the flexure blade thicknesses 312-316 can be varied based on an application of the monolithic pivot bearing 200. Accordingly, if the monolithic pivot bearing 200 is being used for larger applications, such as if a diameter of the monolithic pivot bearing 200 exceeds two inches, the flexure blade thicknesses 312-316 can be increased. In particular, the flexure blade thicknesses 312-316 can be increased from a first thickness to a second thickness. In addition, if the monolithic pivot bearing 200 is being used for smaller applications, such as if a diameter of the monolithic pivot bearing 200 is smaller than two inches, the flexure blade thicknesses 312-316 can be decreased from a first thickness to a second thickness. Also, based on the application and a diameter of the monolithic pivot bearing 200, the flexure blade thicknesses 312-316 can vary relative to each other as discussed above. Moreover, a flexure geometry of the flexure blades 206-210 can be tailored based on travel, cyclical life, and load requirements.

Furthermore, the monolithic pivot bearing 200 is described as having three sets of flexure blades 206-210 that are equally spaced apart in a radial direction about the inner portion center 218. Similar to varying characteristics of the flexure blades 206-210 based on an application to the monolithic pivot bearing 200, a number of flexure blades 206-210 can also be varied. Thus, for larger applications as described above, a greater number of the flexure blades 206-210 can be incorporated into the monolithic pivot bearing 200, such as four sets equally spaced apart in a radial direction about the inner portion center 218, five sets equally spaced apart in a radial direction about the inner portion center 218, or any other number of sets equally spaced apart in a radial direction about the inner portion center 218. Characteristics of the flexure blades 206-210 can also be varied as described above in addition to varying the number of sets of flexure blades 206-210 used in the monolithic pivot bearing 200.

As noted above, the monolithic pivot bearing described herein can be fabricated from a single piece of material thereby avoiding welding, brazing, and/or multiple joints along with the propensity of failure that welding, brazing, and/or multiple joints can cause. The monolithic pivot bearing can be fabricated using an injection molding process, a casting process, or any other type of process that allows for the formation of a monolithic article such as a monolithic pivot bearing where the final product is rigid while allowing for flexing of flexure blades as described above, such as three-dimensional printing, wire EDM, or any other type of process. Materials that can be used can include any type of metal alloy, such as titanium, any type of polymer that can include plastics, or any type of composite.

### Additional Examples

Example 1 is a monolithic pivot bearing comprising: an outer cylindrical portion having an inner surface where a limiter having a first width extends from the outer cylindrical portion inner surface; an inner portion disposed within the outer cylindrical portion and rotatable with respect to the outer cylindrical portion, the inner portion defining: a limiter recess extending from a top surface of the inner portion towards a center of the inner portion, wherein the limiter recess has a second width greater than the first width and the limiter recess is configured to receive the limiter where the first width and the second width define a travel range of the monolithic pivot bearing; and a plurality of flexure blade recesses extending from the inner portion top surface towards the inner portion center; and a plurality of flexure blades that each: have a serpentine configuration; extend from the outer cylindrical portion inner surface and within the plurality of flexure blade recesses; and operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

In Example 2, the subject matter of Example 1 includes, a coupling member extending from the inner portion center wherein the coupling member is configured to couple an article with the inner portion such that the article rotates in the first direction relative to the outer cylindrical portion via the inner portion and the article rotates in the second direction relative to the outer cylindrical portion via the inner portion.

In Example 3, the subject matter of Examples 1 and 2 includes, wherein the plurality of flexure blades includes three flexure blades equally spaced apart in a radial direction about the inner portion center.

In Example 4, the subject matter of Examples 1–3 includes, wherein each of the plurality of flexure blades comprises: a first blade extending from the outer cylindrical portion inner surface; a second blade extending perpendicularly from the first blade in a third flexure blade position; and a third blade extending perpendicularly from the second blade and parallel to the first blade in the third flexure blade position, wherein the third blade extends to the inner portion inner surface such that the second blade is perpendicular relative to the first blade and the third blade.

In Example 5, the subject matter of Example 4 includes, wherein the third blade extends towards the first blade in the first flexure blade position and the second blade extends at an acute angle relative to the first blade and the third blade.

In Example 6, the subject matter of Example 5 includes, wherein the third blade extends away from the first blade in the second flexure blade position and the second extends at an obtuse angle relative to the first blade and the third blade.

In Example 7, the subject matter of Examples 4–6 includes, wherein the first blade has a first blade length and the third blade has a third blade length that is less than the first blade length.

Example 8 is a monolithic pivot bearing comprising: an outer cylindrical portion; an inner portion disposed within the outer cylindrical portion and rotatable with respect to the outer cylindrical portion, the inner portion defining a plurality of flexure blade recesses extending from a top surface of the inner portion towards a center of the inner portion; and a plurality of flexure blades that each: have a serpentine configuration; extend from and inner surface of the outer cylindrical portion and within the plurality of flexure blade recesses; and operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

In Example 9, the subject matter of Example 8 includes, having an inner surface where a limiter having a first width extending from an inner surface of the outer cylindrical portion inner; and a limiter recess extending from the inner portion top surface towards the inner portion center, wherein the limiter recess has a second width greater than the first width and the limiter recess is configured to receive the limiter where the first width and the second width define a travel range of the monolithic pivot bearing.

In Example 10, the subject matter of Examples 8 and 9 includes, wherein the plurality of flexure blades includes three flexure blades equally spaced apart in a radial direction about the inner portion center.

In Example 11, the subject matter of Examples 8–10 includes, wherein each of the plurality of flexure blades comprises: a first blade extending from the outer cylindrical portion inner surface; a second blade extending perpendicularly from the first blade in a third flexure blade position; and a third blade extending perpendicularly from the second blade and parallel to the first blade in the third flexure blade position, wherein the third blade extends to the inner portion inner surface such that the second blade is perpendicular relative to the first blade and the third blade.

In Example 12, the subject matter of Example 11 includes, wherein the third blade extends towards the first blade in the first flexure blade position and the second blade extends at an acute angle relative to the first blade and the third blade.

In Example 13, the subject matter of Example 12 includes, wherein the third blade extends away from the first blade in the second flexure blade position and the second extends at an obtuse angle relative to the first blade and the third blade.

Example 14 is a monolithic pivot bearing comprising: an outer cylindrical portion; an inner portion disposed within the outer cylindrical portion and rotatable with respect to the outer cylindrical portion, the inner portion defining a plurality of flexure blade recesses extending from a top surface of the inner portion towards a center of the inner portion; and a plurality of flexure blades that each: have a serpentine configuration; extend from the outer cylindrical portion inner surface and within the plurality of flexure blade recesses that ; and operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

In Example 15, the subject matter of Example 14 includes, having an inner surface where a limiter having a first width extending from an inner surface of the outer cylindrical portion inner; and a limiter recess extending from the inner portion top surface towards the inner portion center, wherein the limiter recess has a second width greater than the first width and the limiter recess is configured to receive the limiter where the first width and the second width define a travel range of the monolithic pivot bearing.

In Example 16, the subject matter of Examples 14 and 15 includes, wherein each of the plurality of flexure blades have a serpentine configuration and extend from and inner surface of the outer cylindrical portion and within the plurality of flexure blade recesses.

In Example 17, the subject matter of Examples 14–16 includes, having an inner surface where a limiter having a first width extending from an inner surface of the outer cylindrical portion inner; and a limiter recess extending from the inner portion top surface towards the inner portion center, wherein the limiter recess has a second width greater than the first width and the limiter recess is configured to receive the limiter where the first width and the second width define a travel range of the monolithic pivot bearing.

In Example 18, the subject matter of Examples 14–17 includes, wherein each of the plurality of flexure blades comprises: a first blade extending from the outer cylindrical portion inner surface; a second blade extending perpendicularly from the first blade in a third flexure blade position; and a third blade extending perpendicularly from the second blade and parallel to the first blade in the third flexure blade position, wherein the third blade extends to the inner portion inner surface such that the second blade is perpendicular relative to the first blade and the third blade.

In Example 19, the subject matter of Example 18 includes, wherein: the third blade extends towards the first blade in the first flexure blade position and the second blade extends at an acute angle relative to the first blade and the third blade; and the third blade extends away from the first blade in the second flexure blade position and the second extends at an obtuse angle relative to the first blade and the third blade.

Example 20 is an apparatus comprising means to implement of any of Examples 1–20.

Example 21 is a method to implement of any of Examples 1–20.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A monolithic pivot bearing comprising:
an outer cylindrical portion having an inner surface where a limiter having a first width extends from the outer cylindrical portion inner surface;
an inner portion disposed within the outer cylindrical portion and rotatable with respect to the outer cylindrical portion, the inner portion defining:
a limiter recess extending from a top surface of the inner portion towards a center of the inner portion, wherein the limiter recess has a second width greater than the first width and the limiter recess is configured to receive the limiter where the first width and the second width define a travel range of the monolithic pivot bearing; and
a plurality of flexure blade recesses extending from the inner portion top surface towards the inner portion center; and
a plurality of flexure blades that each:
have a serpentine configuration;
extend from the outer cylindrical portion inner surface and within the plurality of flexure blade recesses; and
operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

2. The monolithic pivot bearing of claim 1, further comprising a coupling member extending from the inner portion center wherein the coupling member is configured to couple an article with the inner portion such that the article rotates in the first direction relative to the outer cylindrical portion via the inner portion and the article rotates in the second direction relative to the outer cylindrical portion via the inner portion.

3. The monolithic pivot bearing of claim 1, wherein the plurality of flexure blades includes three flexure blades equally spaced apart in a radial direction about the inner portion center.

4. The monolithic pivot bearing of claim 1, wherein each of the plurality of flexure blades comprises:
a first blade extending from the outer cylindrical portion inner surface;
a second blade extending perpendicularly from the first blade in a third flexure blade position; and
a third blade extending perpendicularly from the second blade and parallel to the first blade in the third flexure blade position, wherein the third blade extends to the inner portion inner surface such that the second blade is perpendicular relative to the first blade and the third blade.

5. The monolithic pivot bearing of claim 4, wherein the third blade extends towards the first blade in the first flexure blade position and the second blade extends at an acute angle relative to the first blade and the third blade.

6. The monolithic pivot bearing of claim 5, wherein the third blade extends away from the first blade in the second flexure blade position and the second extends at an obtuse angle relative to the first blade and the third blade.

7. The monolithic pivot bearing of claim 4, wherein the first blade has a first blade length and the third blade has a third blade length that is less than the first blade length.

8. A monolithic pivot bearing comprising:
an outer cylindrical portion;
an inner portion disposed within the outer cylindrical portion and rotatable with respect to the outer cylindrical portion, the inner portion defining a plurality of flexure blade recesses extending from a top surface of the inner portion towards a center of the inner portion; and
a plurality of flexure blades that each:
have a serpentine configuration;
extend from and inner surface of the outer cylindrical portion and within the plurality of flexure blade recesses; and
operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

9. The monolithic pivot bearing of claim 8, further comprising:
having an inner surface where a limiter having a first width extending from an inner surface of the outer cylindrical portion inner; and
a limiter recess extending from the inner portion top surface towards the inner portion center, wherein the limiter recess has a second width greater than the first width and the limiter recess is configured to receive the limiter where the first width and the second width define a travel range of the monolithic pivot bearing.

10. The monolithic pivot bearing of claim 8, wherein the plurality of flexure blades includes three flexure blades equally spaced apart in a radial direction about the inner portion center.

11. The monolithic pivot bearing of claim 8, wherein each of the plurality of flexure blades comprises:
a first blade extending from the outer cylindrical portion inner surface;
a second blade extending perpendicularly from the first blade in a third flexure blade position; and
a third blade extending perpendicularly from the second blade and parallel to the first blade in the third flexure blade position, wherein the third blade extends to the inner portion inner surface such that the second blade is perpendicular relative to the first blade and the third blade.

12. The monolithic pivot bearing of claim 11, wherein the third blade extends towards the first blade in the first flexure blade position and the second blade extends at an acute angle relative to the first blade and the third blade.

13. The monolithic pivot bearing of claim 12, wherein the third blade extends away from the first blade in the second flexure blade position and the second extends at an obtuse angle relative to the first blade and the third blade.

14. A monolithic pivot bearing comprising:
an outer cylindrical portion;
an inner portion disposed within the outer cylindrical portion and rotatable with respect to the outer cylindrical portion, the inner portion defining a plurality of flexure blade recesses extending from a top surface of the inner portion towards a center of the inner portion; and
a plurality of flexure blades that each:
have a serpentine configuration;
extend from the outer cylindrical portion inner surface and within the plurality of flexure blade recesses that ; and operatively couple the outer cylindrical portion with the inner portion at an inner surface of the inner portion, wherein the plurality of flexure blades flex into a first flexure blade position when one of the inner portion and the outer cylindrical portion rotates in a first direction relative to the other of the inner portion and the outer cylindrical portion and wherein the plurality of flexure blades flex into a second flexure blade position when one of the inner portion and the outer cylindrical portion rotates in a second direction relative to the other of the inner portion and the outer cylindrical portion that is opposite to the first direction.

15. The monolithic pivot bearing of claim 14, further comprising:
having an inner surface where a limiter having a first width extending from an inner surface of the outer cylindrical portion inner; and
a limiter recess extending from the inner portion top surface towards the inner portion center, wherein the limiter recess has a second width greater than the first width and the limiter recess is configured to receive the limiter where the first width and the second width define a travel range of the monolithic pivot bearing.

16. The monolithic pivot bearing of claim 14, wherein each of the plurality of flexure blades have a serpentine configuration and extend from and inner surface of the outer cylindrical portion and within the plurality of flexure blade recesses.

17. The monolithic pivot bearing of claim 14, further comprising:
having an inner surface where a limiter having a first width extending from an inner surface of the outer cylindrical portion inner; and
a limiter recess extending from the inner portion top surface towards the inner portion center, wherein the limiter recess has a second width greater than the first width and the limiter recess is configured to receive the limiter where the first width and the second width define a travel range of the monolithic pivot bearing.

18. The monolithic pivot bearing of claim 14, wherein each of the plurality of flexure blades comprises:
a first blade extending from the outer cylindrical portion inner surface;
a second blade extending perpendicularly from the first blade in a third flexure blade position; and
a third blade extending perpendicularly from the second blade and parallel to the first blade in the third flexure blade position, wherein the third blade extends to the inner portion inner surface such that the second blade is perpendicular relative to the first blade and the third blade.

19. The monolithic pivot bearing of claim 18, wherein:
the third blade extends towards the first blade in the first flexure blade position and the second blade extends at an acute angle relative to the first blade and the third blade; and
the third blade extends away from the first blade in the second flexure blade position and the second extends at an obtuse angle relative to the first blade and the third blade.
